(19) United States
(12) Patent Application Publication
(10) Pub. No.: US 2007/0140116 A1
(43) Pub. Date: Jun. 21, 2007

(54) Interactive Codec Selection

(75) Inventor: Andres Vega-Garcia, Newcastle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,194

(22) Filed: Dec. 16, 2005

(51) Int. Cl. H04L 12/26; H04J 1/16

(52) U.S. Cl. 370/230; 370/252

(57) ABSTRACT

A codec selection process is independent of a codec source. A codec table may be used that includes indexed codec references related to codecs stored in a codec source. The codec table and the codec source may be modified without affecting a codec selection process. This feature of an exemplary implementation makes it fairly straightforward to add, change, or otherwise modify codecs stored in the codec source and referenced in the codec table without having to change the codec selection process.

### BACKGROUND

Communication bandwidth is becoming an increasingly valuable commodity. Media signals, including audio and video signals, may consume enormous amounts of bandwidth depending on a desired transmission quality. Thus, robust techniques for compressing (encoding) media signals have become increasingly important.

Generally, a party sending media signals selects a codec (compressor/decompressor) for encoding the media signals. The party sending the media signals normally selects a codec based on various properties of a current communication session.

A wide variety of codecs are available form various sources. General codec classifications include discrete cosign transfer codecs, fractal codecs, and wavelet codecs. A party receiving the encoded media signals decodes the signals using an appropriate codec.

Conventional codec selection mechanisms are often designed rigidly. Therefore, the codec selection mechanisms are fairly difficult to adapt to accommodate increases in bandwidth and processing capability, improved communication mediums and changes in the characteristics of media signals. When codec advances occur or additional codes are created, current selection mechanisms often require significant retooling to support the improved codecs.

### SUMMARY

Arrangements and methods are described that provide highly extensible codec selection implementations. In one exemplary implementation, the codec selection process is not directly associated with a codec source. A codec table may be used that includes indexed codec references related to codecs stored in a codec source. The codec table and the codec source may be modified without affecting a codec selection process. This feature of the exemplary implementation makes it fairly straightforward to add, change, or otherwise modify codecs stored in the codec source and referenced in the codec table without having to change the codec selection process.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an exemplary communication arrangement. The arrangement includes a source computing device communicating with a destination computing device.

FIG. 2 illustrates exemplary codec (compressor/decompressor) tables associated with a source computing device.

FIG. 3 illustrates various properties of a communication session that may be received and considered by a codec selection process.

FIGS. 4-6 illustrate a flow diagram of a process for selecting one or more codecs for use by a source computing device.

FIG. 7 is a block diagram illustrating functional components in a computing device that might be used to implement the device illustrated in FIG. 1.

### DETAILED DESCRIPTION

Overview

The following disclosure describes an extensible codec (compressor/decompressor) selection arrangement and method capable of selecting codecs used to encode media signals. In one implementation, extensibility is achieved by separating the actual codecs from the process used to select the codecs. Therefore, once the process used to select codecs is implemented in a computing device and the codecs are stored in a repository, one must merely modify, add, and/or remove codecs stored in the repository when the need arises. That is, the codec selection process is left untouched as codecs are modified, added and/or removed from the repository. This allows an arrangement employing one or more implementations described herein to quickly and easily adapt to improvements in codec design and/or changes in communication technologies used to disseminate media signals.

An exemplary communication arrangement having a source computing device in communication with a destination computing device is described first in the following description. The description related to the communication arrangement is intended to provide context related to communication of encoded media signals over a network. The foregoing is followed by a description of an exemplary implementation of a source computing device. Then, an exemplary process for selecting one or more codecs for use in encoding media signals is described. Finally, a general computing device is discussed.

Exemplary Arrangement

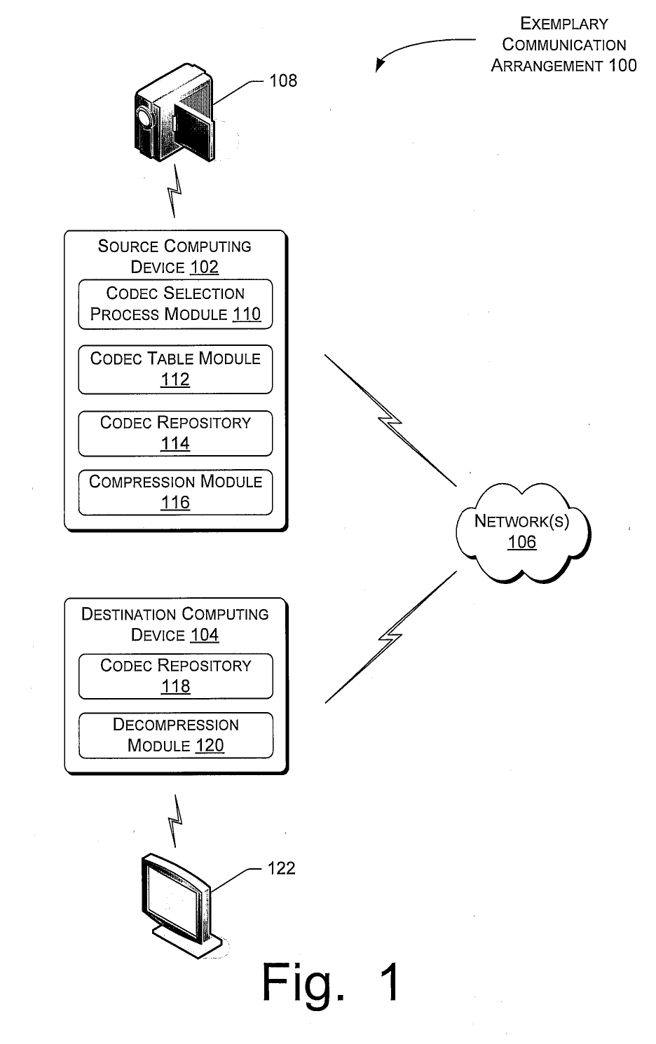

FIG. 1 illustrates an exemplary communication arrangement 100 that may be used in conjunction with codec (compressor/decompressor) selection implementations described herein. The exemplary communication arrangement 100 includes a source computing device 102 in communication with a destination computing device 104. The communication between the computing devices 102 and 104 is facilitated through a network 106. The network 106 is representative of many different types of networks, such as cable networks, the Internet, and wireless networks.

The source computing device 102 is interfaced with a camera 108. The source computing device 102 may be connected to a variety of other devices as well. The interface between the device 102 and the camera 108 may be realized using line or wireless technologies. The camera 108 sends the source computing device 102 media signals that may include audio, video, still digital pictures, and the like.

The source computing device 102 has various hardware and/or software components that process media signals. In particular, the device 102 includes a codec selection process module 110. that has instructions for selecting codecs that are used to encode received media signals. Such received media signals may originate from the camera 108. In the process of selecting codecs appropriate for encoding received media signals, the codec selection process module 110 may reference a codec table module 112. The codec table module 112 includes one or more codec tables that contain indexed references to codecs stored in a codec repository 114. The one or more codec tables may be modified without changing the codec selection process module 110. This is true for the codec repository 114.

The codec selection process module 110 assesses a total bandwidth available to the source computing device 102. The total bandwidth is affected by the type of communication connection established between the source computing device 102 and the network 106. For example, a communication connection using a 28.8 kbps modem offers far less bandwidth than a communication connection using a DSL or cable modem connection. Other factors that may affect the total bandwidth include average packet loss over the network 108, the type of media requiring encoding and dissemination over the network 108, and/or the computational capacity of the computing device 102. A user of the source computing device 102 may also directly select the total bandwidth available to the computing device 102.

Once the total bandwidth is known, the codec selection process module 110 searches the codec table module 112. Specifically, the codec table module 112 is searched for a codec reference associated with a codec that is appropriate to encode the current media signal. Generally, the codec reference selected depends on the total bandwidth available. If the source computing device 102 is handling more than one media signal, or a media signal that includes distinct media components (e.g., audio and video media) that require encoding by separate codecs, more than one codec reference may be selected.

The codec repository 114 stores the actual codecs used to encode media signals processed by the computing device 110. At least some or all of the codecs stored in the codec repository 114 are referenced in the codec table module 112. The codec repository 114 provides codecs to a compression module 116, which is responsible for encoding media signals processed by the source computing device 116. Instructions to pass codecs to the compression module 116 come from the codec table module 112. These instructions will generally include the codec identifiers associated with the codecs stored in the codec repository 116.

The compression module 116 encodes media signals processed by the source computing device 102 using one or more codecs stored in the codec repository 114. Once the media signals are encoded, they are sent over the network 106 to the destination computing device 104.

The destination computing device 104 includes a codec repository 118 and a decompression module 120. The codec repository 118 generally contains the same codecs stored in the codec repository 114. Using one or more codecs of the repository 118, the decompression module 120 decodes encoded media signals received from the source computing device 102. The decoded media signals are then communicated to a display device 122, such as a computer display interfaced directly to the destination computing device 104 or a television.

The codec repositories 114 and 118 contain a wide variety of audio and video codecs. Examples of possible codecs stored in the repositories 114 and 118 are MPEG Audio Layer (MP3), MPEG-4 Structure Audio (MP4-SA), CCITT u-Law, Ogg Vorbis, AC3, H.261, and H.263. Other presently available and later developed codecs may be stored in the repository 114 and used with the exemplary implementations described herein.

As is readily understood from the foregoing description of the exemplary communication arrangement 100, the source computing device 102 is modularly designed with respect to the components responsible for codes selection. Therefore, the computing device 102 can be updated with new and/or additional codecs without having to redesign the process used to select codecs. This is advantageous because communication technologies generally change at a very rapid pace.

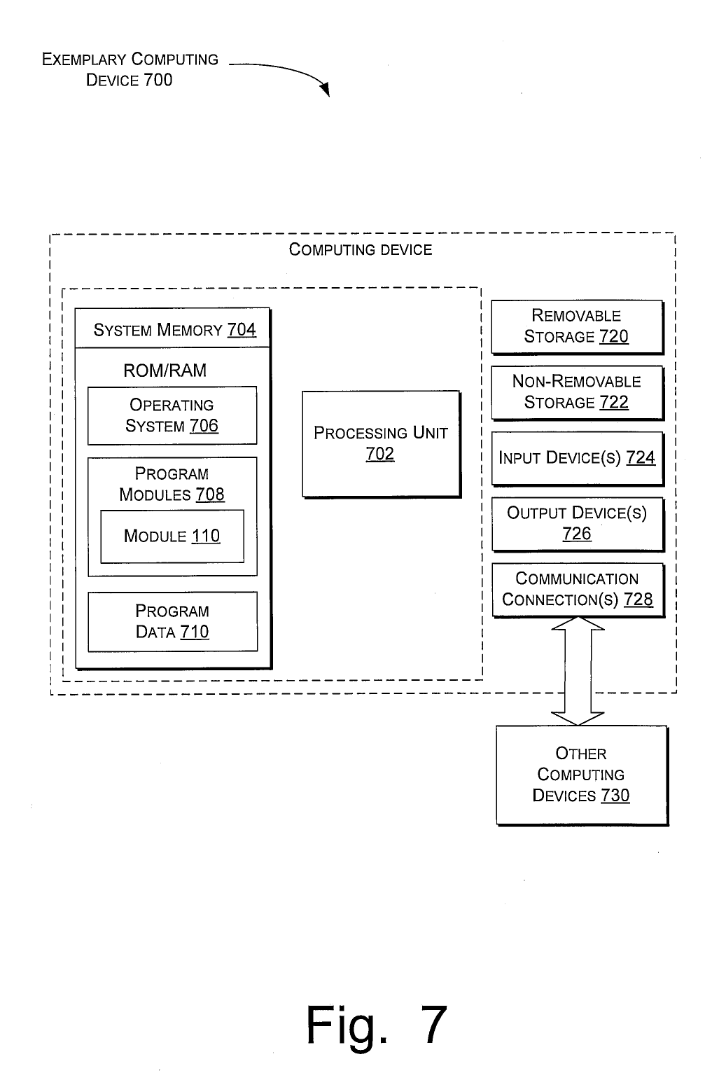

The modules and repositories illustrated in FIG. 1 may be implemented as software or computer-executable instructions stored in a memory of a client(s)/server(s) and executed by one or more processors of the client(s)/server(s). The memory may be implemented as non-removable persistent storage of the clients/servers, although other suitable computer storage media may also be used to store the modules and repositories. An example of a computer device is provided below with reference to FIG. 7.

Codec Table Implementation

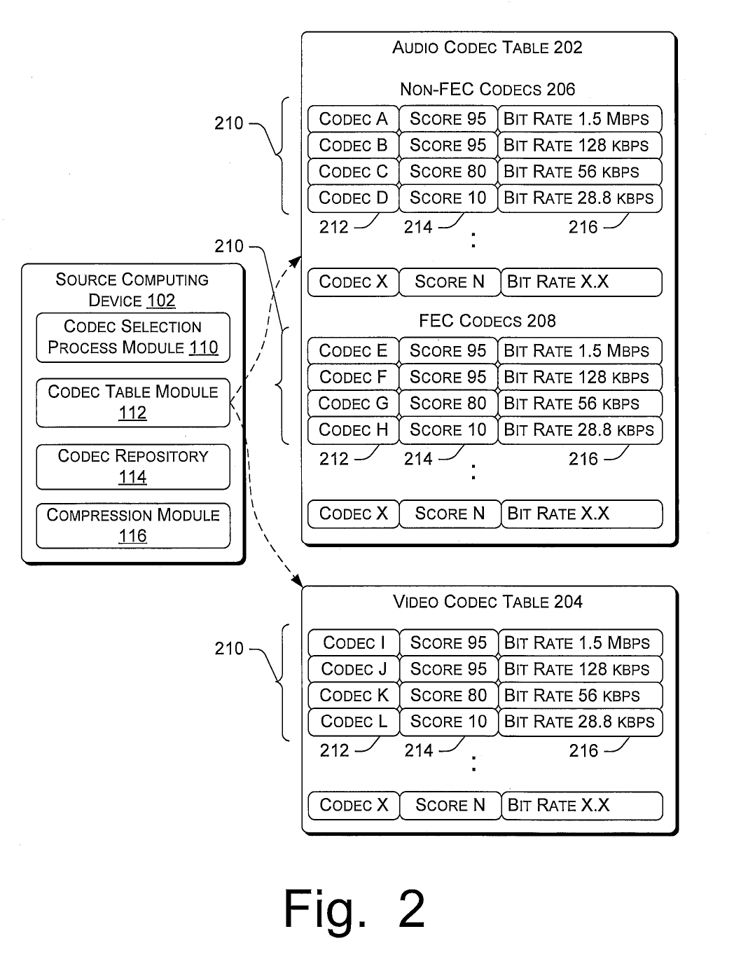

FIG. 2 illustrates codec tables that are implemented by the codec table module 112. In the exemplary implementation illustrated in the figure, the table module 112 comprises an audio codec table 202 and a video codec table 204. The tables 202 and 204 are shown as separate tables, but they may be combined into one table if such an implementation is preferred. The tables 202 and 204 may be modified without changing the codec selection process module 110.

The audio codec table 202 and the video codec table 204 include references to codecs stored in the codec repository 118. The tables 202 and 204 may be generally considered searchable indexes that may be used to select codecs stored in the codec repository 118.

The Audio codec table 202 includes a non-FEC (forward error correction) codec reference section 206 and an FEC codec section 208. Those skilled in the art appreciate that choosing an FEC codec over a non-FEC codec depends on the quality of a communication session established between entities. If the communication session is degraded by noise, loss and distortion, FEC codecs may be used to encode media signals. The FEC codecs add redundancy to the encoded media signals so that a destination entity can properly reproduce the encoded media signals. However, the redundancy added to the encoded media signals will generally increase the bandwidth requirements needed to properly send the encoded media signals. Accordingly, if a communication session is not unduly burdened by noise, loss and distortion, selection of non-FEC codecs will provide superior encoding of media signals.

The audio codec table 202 and the video codec table 208 each include a number of codec references 210. Each codec reference 210 includes a codec name field 212, a score field 214 and a bit rate field 216. The codec name field 212 has a name of one of the codecs stored in the codec repository 114. The codec name field 212 may also include a codec owner's name, a common abbreviation associated with the codec, and so forth.

The score field 214 and the bit rate field 216 are designed to ensure an appropriate codec reference 2110 is selected by the codec selection process module 110. As will be apparent from the following description, one or both of the fields 214 and 216 may be used to determine which codec reference 210 is chosen by the codec selection process module 110. More than one codec reference 210 may be selected by the process module 110, depending on the type and number of media signals being processed by the source computing device 102.

The score field 214 contains a score representative of a computing device's processing capability. There are many ways of determining the processing capability of a computing device. One generic measure looks at the raw processing power of a device's central processing unit (CPU). A CPU is generally considered more powerful than another CPU if the former can process more instructions per second. Therefore, a device having a CPU that can process 100 million instructions per second (MIPS) might be given a score of 95 and a device having a CPU that can process 85 MIPS might be given a score of 80. In general, higher scores represent higher performance computing devices. The given scores are exemplary. Another entity may score a CPU that can process 100 MIPS higher or lower than the given score of 95.

Other factors that might be used to generate a score contained in a score field 214 may include a computing device's bus architecture, data bus width, clocking, and the like. The described implementations are not limited to one specific device scoring technique. The scoring technique used may directly depend on the design requirements of a computing device comprising the codec selection implementations described herein.

A value present in a given bit rate field 216 represents a maximum network bandwidth that is supported by a codec identified in a related codec name field 212. For example, “CD quality” audio includes two charmers of signal data that equal a real-time bit rate of 1,411,200 bits per second. Therefore, communication sessions having a bandwidth that is less than 1.4 Mbps will require a reduction in the number of bits included in the CD quality audio. In the case of one ISDN line (128 kbps), a 12:1 bit reduction is required to “fit” the CD quality audio into the bandwidth that is provided by the ISDN connection. Therefore, the codec B, index referenced in the non-FEC codecs section 206, may be a good choice if encoding of CD quality audio is required, the communication connection is relatively robust (e.g., little or no noise and packet loss), and the available bandwidth is not greater than 128 kbps. In general, a codec is eligible for selection if its bandwidth requirements are less or equal the available bandwidth.

The fields 212-216 of the video codec table 204 are similar to the fields 212-216 discussed in connection with the audio codes table 202. However, it should be understood that the codec references I-L point to video codecs stored in the codec repository 114. Unless a codec is specifically designed to process both audio and video media signals, encoding a video signal will require a codec that is specifically designed for encoding video signals. Similarly, encoding an audio signal will require a codec that is specifically designed for encoding audio signals. Therefore, in many cases, a media signal that comprises both an audio component and a video component requires two codecs to completely encode the media signal (i.e., one audio codec and one video codec). However, as will be described later, depending on the available bandwidth or other considerations, one component of a media signal may be sacrificed in favor of efficiently encoding and delivering another component of the media signal.

The fields associated with the codecs illustrated in FIG. 2 are merely exemplary. That is, a given codec may have additional fields that may be used by the selection process module 110 during a process of choosing an appropriate codec for encoding a media signal. A number of codecs may be listed in the tables 202 and 204 that are each appropriate for a particular maximum bandwidth value. Moreover, these codecs may also have the same score value. The selection process module 110, in such a case, often picks a codec based on other criteria (e.g., audio quality). For example, it may be better to encode a stereo audio signal with a codec that is designed for high-fidelity audio, as opposed to using a codec that is meant for all-types of audio signals.

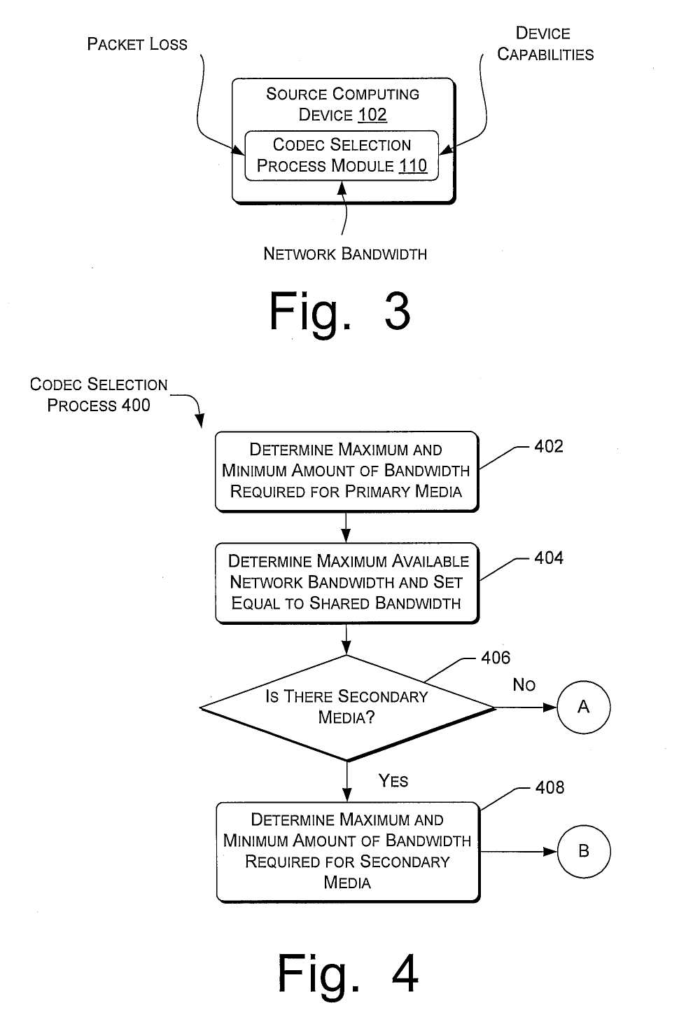

FIG. 3 illustrates various inputs that the source computing device 102, more particularly the codec selection process module 110, may consider before selecting codecs used to encode media signals. The inputs shown in the figure include packet loss, device capabilities and network bandwidth. Techniques and methods for measuring the stated inputs are known to those skilled in the art. Nonetheless, a brief discussion of at least one measurement technique for determining packet loss, device capabilities and network bandwidth is provided in the following. In one exemplary implementation, the codec selection process module 110 performs the indicated measurements.

Packet loss may be measured using a special packet designed to get a response back from a destination computing device (e.g., the device 104), much like the echo of a sonar ping used to detect objects underwater. Such a special packet is often referred to as a “ping packet.” It is possible to send several (or even continuous) ping packets in succession over a network to a destination computing device. The number of responses returned from the destination computing device may be used to calculate an average packet loss of a current communication session.

Determining the capabilities of a computing device may be as simple as evaluating the raw processing power of a device's CPU. Such an evaluation will give a MIPS value. Higher MIPS values normally indicate higher performing computing devices. Other Factors may also be used in determining a computing device's capabilities. These factors commonly include bus architecture, data bus width, and chip clocking values. After evaluating the capabilities of the computing device, a score is generated that is indicative of the general computational power and performance of the device.

Measuring bandwidth available to a computing device may be fairly straightforward, but the process may be non-trivial as well. One popular bandwidth measuring technique involves polling the technology facilitating communication with a network (e.g., the network 106). Polling of the facilitating technology generates feedback indicating a maximum bandwidth capability of the technology. Telephone modems, cable modems and DSL modems are a few examples of technologies that facilitate communication with a network.

The three inputs shown in FIG. 3 may be considered by the codec selection process module 110 before codec index references are chosen from the codec table module 112. The packet loss and network bandwidth inputs are used by the codec selection process module 110 to determine a maximum bandwidth that is offered by the network 106. This maximum bandwidth value is compared against the bit rate fields 216 contained in one of the relevant codec tables 202 or 204. More specifically, if an audio signal needs encoding, the audio codec table 202 is searched. The video codec table 208 is searched if a video signal needs encoding.

In addition to the maximum available bandwidth, the codec selection process module 110 may also consider the device capabilities input illustrated in FIG. 3 when selecting codec index references of the codec table module 112. As describe earlier, consideration of a computing device's capabilities results in the rendering of a score that is indicative of the general computational power and performance of the device. The rendered score is compared against the score fields 214 referenced in one of the codec tables 202 or 204. More specifically, if an audio signal needs encoding, the audio codec table 202 is searched. The video codec table 208 is searched if a video signal needs encoding.

The codec selection process module 110 may use the determined maximum available bandwidth alone when selecting codecs referenced in the tables 202 and 204. Alternatively, the determined maximum available bandwidth and the score determined from a device's capabilities may be used when selecting codecs referenced in the tables 202 and 204. If only the maximum available bandwidth is used, the codec selection process module 110 searches the relevant table 202 or 204 for an indexed codec that has a bit rate value that is less than the maximum available bandwidth. Bit rate values are in the bit rate fields 216. The process module 110 will choose an indexed codec that has a bit rate value that is closest to the maximum available bandwidth.

If the determined maximum available bandwidth and the score determined from a device's capabilities are used together, selection of an appropriate codec reference necessitates checking the score fields 214 and the bit rate fields 216 indexed in one of the tables 202 or 204. The codec selection process module 110 references the relevant table 202 or 204 and chooses a codec reference that includes a score that does not exceed the score determined from the device's capabilities. Furthermore, the chosen codec reference should have a bit rate value that is less than the maximum available bandwidth.

In another exemplary implementation, the codec selection process module 110 reviews the codecs referenced in the tables 202 and 204 before considering the inputs illustrated in FIG. 3. Such a review may include identifying those codecs that support similar or the same bandwidth levels. Furthermore, the review may include identifying codecs that have the same scores. After this review process, the codec selection process module 110 considers the inputs illustrated in FIG. 3 and selects an appropriate codec(s) referenced in one or both of the tables 202 and 204.

The three inputs illustrated in FIG. 3 and considered by the codec selection process module 110 are exemplary examples of many other parameters that may be considered by a codec selection process. Such other parameters may be used by the selection process module 110 to aid in the selection of codecs used for encoding media signals.

Exemplary Codec Selection Process

FIGS. 4-6 illustrate an example codes selection process 400. The process is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

For discussion purposes, the processes are described with reference to the communication arrangement 100 of FIG. 1. In particular, many acts described below may be implemented and performed by various components of the source computing device 102 illustrated in FIGS. 1-3. In one implementation, the codec selection process module 110 executes the acts described below.

Referring to FIG. 4, at block 402, the source computing device 102 determines a maximum and minimum amount of bandwidth that is required for a primary media. In some cases, media will be comprised of distinct media types. For example, video media includes audio and video media components. The source computing device 102 distinguishes between the various media components of a given media signal to ensure proper codec selection. If a media signal includes distinct media types, the source computing device 102 will give one of the distinct media types priority over the other.

In one exemplary implementation, when a video signal is received, the source computing device 102 designates the audio component as the primary media. The video component is designated as the secondary media. In another implementation, the video component is designated as the primary media and the audio component is designated as the secondary media. As will be appreciated in the following description, designating primary and secondary media normally ensures that there is enough bandwidth to properly encode and convey at least one of the designated media.

Returning again to block 402, the maximum amount of bandwidth required for the primary media may be trivial. That is, without bandwidth restraints or other considerations, the maximum amount of bandwidth required for the primary media may be set to the maximum available bandwidth of a current communication session. This would reduce or eliminate an amount of encoding required to successfully transmit the primary media over the network 106.

The minimum amount of bandwidth required for the primary media often depends on the type and quality of the media that will undergo encoding. For example, if the primary media is CD quality audio, there may be a minimum available bandwidth requirement needed to maintain the fidelity of the audio signal after encoding. More specifically, if a lower bandwidth were accepted, a codec used to encode the CD quality audio would unacceptably degrade the signal.

At block 404, the source computing device 102 determines an available bandwidth associated with a current communication session with the destination computing device 104. The computing device 102 sets the available bandwidth equal to a shared bandwidth value. At block 406, the computing device 102 determines if there is a secondary media type. If there is a secondary media type, at block 408, the source computing device 102 determines a maximum and minimum amount of bandwidth that is required for a secondary media. The same process used to determine the maximum and minimum amount of bandwidth required for the primary media is carried out for the secondary media.

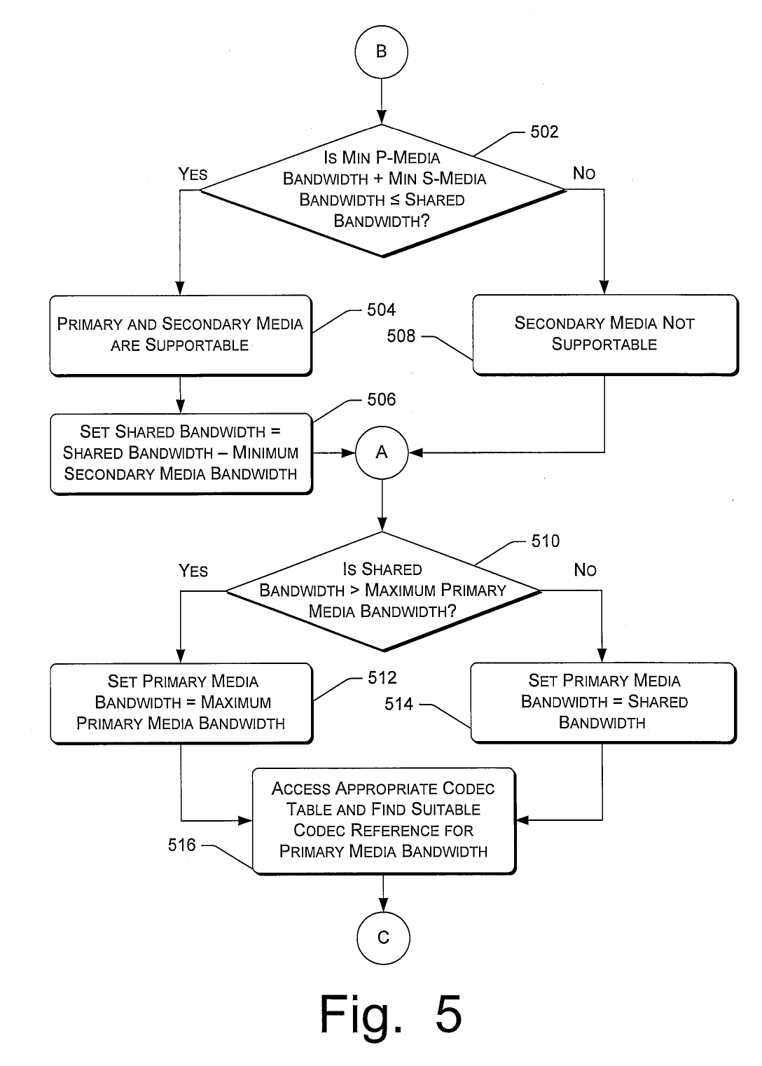

Following connector B, as is illustrated in FIG. 5, at block 502 the source computing device 102 determines if the minimum amount of bandwidth required by the primary media summed with the minimum amount of bandwidth required by the secondary media is less than or equal to the shared bandwidth set at block 404. If yes, at block 504, both the primary and secondary media are supportable. At block 506, the shared bandwidth is reset to equal the shared bandwidth set at block 404 minus the minimum bandwidth required by the secondary media type. The minimum bandwidth required by the secondary media was determined at block 408. This minimum bandwidth required by the secondary media is by default the amount of bandwidth allocated thereto if the media is supported.

If, at block 502, the source computing device 102 determines that there is not sufficient shared bandwidth, the secondary media is not supportable (block 508). This means that the secondary media will not be encoded and sent to the destination computing device 104.

The process continues at connector A in FIG. 5. A portion of the codec selection process 400 illustrated in FIG. 4 connects with the connector A. This is true when the instructions of block 406 determine that a media signal being processed by the source computing device 102 does not include a secondary media. For example, this may occur if a media signal comprises an audio only component.

At block 510, the source computing device 102 determines if the shared bandwidth is greater than the maximum bandwidth required by the primary media. The shared bandwidth was set at block 404, or the shared bandwidth was modified subsequently at block 506. If the shared bandwidth is greater than the maximum bandwidth required by the primary media, a primary media bandwidth allocated to the primary media is set to the maximum bandwidth required by the primary media (block 512). Otherwise, at block 514, the primary media bandwidth allocated to the primary media is set equal to the shared bandwidth.

Using the primary media bandwidth allocated to the primary media as a reference, the source computing device 102 is now ready to select an appropriate codec. At block 516, the computing device 102 accesses the codes table module 112 to select an indexed codec that will be used to encode the primary media. More particularly, the computing device 102 will select a codec reference that includes an appropriate bit rate reference. The chosen codec reference will have a bit rate reference that is not greater than the bandwidth allocated to the primary media. In some cases, the chosen codec will have a bit rate reference that is substantially equal to the bandwidth allocated to the primary media, and in other cases the bit rate reference will be somewhat lower than the allocated bandwidth. Generally, a greater number of codecs referenced in the codec table module 112 will result in the selection of an indexed codec reference that is equal or substantially equal to the bandwidth allocated to the primary media.

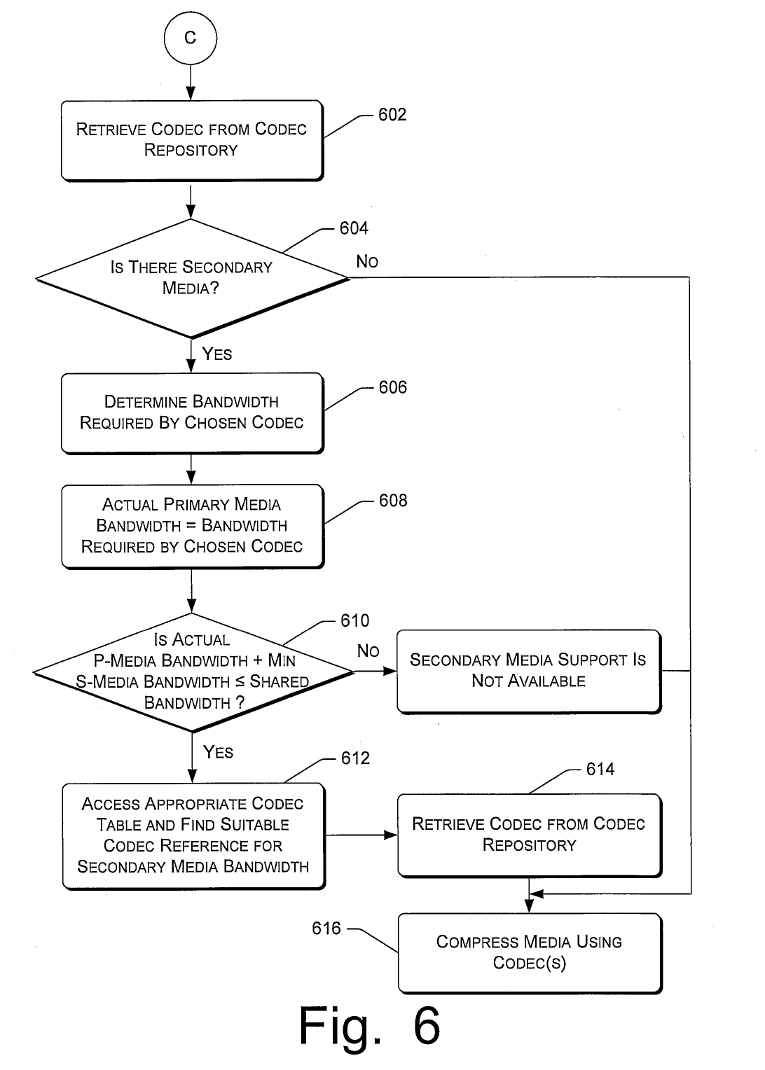

Turning now to FIG. 6, at block 602, the source computing device 102, aided by the codec selection process module 110, retrieves a codec from the codec repository 114. The codec retrieved from the codec repository 114 will match the codec reference chosen from the codec table module 112. The codec retrieved at block 602 will be used to encode the primary media.

If there is at secondary media, which is reevaluated at block 604, the codec chosen at block 516 is evaluated to determine how much bandwidth a media signal encoded therewith will require (block 606). As it understood by those skilled in the art, an encoded media signal will consume less bandwidth than the original unencoded media signal. Nonetheless, the encoded media signal will consume bandwidth. The amount of bandwidth consumed by an encoded media signal is in part a function of the compressing algorithms employed by a given codec. At block 608, an actual bandwidth required by the primary media is set to the bandwidth required by the primary media after it undergoes encoding by the chosen codec. The actual bandwidth required by the primary media may be different (greater) than the primary media bandwidth value set at block 512 or 514. The actual bandwidth value required by the primary media set at block 608 supersedes the primary media bandwidth value set at block 512 or 514.

At block 610, support for the secondary media is reevaluated. The decision process of block 610 is required because the actual bandwidth value required the primary media, when encoded with the chosen codec, may reduce and/or increase an amount of bandwidth available to the secondary media. To determine if the secondary media can still be supported, the actual bandwidth required by the primary media (set at block 608) is summed with the minimum amount of bandwidth required by the secondary media. This minimum amount was determined at block 408. If the summed amount determined at block 610 is less than or equal to the shared bandwidth, then the secondary media is still supportable and can be encoded. The shared bandwidth was set at block 506.

At block 612, the computing device 102 accesses the codes table module 112 to select an indexed codec that will be used to encode the secondary media. More particularly, the computing device 102 will select a codec reference that includes an appropriate bit rate reference. The chosen codec reference will have a bit rate reference that is not greater than the bandwidth allocated to the secondary media. Recall, the bandwidth allocated to the secondary media is the minimum bandwidth required by the secondary media (see block 408). In some cases, the chosen codec will have a bit rate reference that is substantially equal to the bandwidth allocated to the secondary media, and in other cases the bit rate reference will be somewhat lower than the allocated bandwidth. Generally, a greater number of codecs referenced in the codec table module 112 will result in the selection of an indexed codec reference that is equal or substantially equal to the bandwidth allocated to the secondary media.

At block 614, the source computing device 102, aided by the codec selection process module 110, retrieves a codec from the codec repository 114. The codec retrieve from the codes repository 114 will match the codec reference chosen from the codec table module 112. The codec retrieved at block 614 will be used to encode the secondary media. At block 616, the primary and secondary media are encoded using the codecs selected at blocks 516 and 612, respectively.

Returning to block 604, if there is not a secondary media, the process proceeds directly to block 616. Here, the primary media is encoded using the codec selected at block 516.

Signals encoded by way of the described arrangement and process may be sent to a destination computing device (e.g., the device 104) for decoding and consumption. It should be clear from the foregoing description, that the process used to select codecs is not tied to the codecs used to encode media signals. Therefore, adding or removing codecs from a codec reference table and codec repository can occur without changing the process used to select codecs. Therefore, the described codec selection arrangement and process are extensible.

The process described and illustrated in FIGS. 4-6 does not illustrate the use of a device's capabilities in determining codecs for encoding media signals. However, as was discussed earlier, the codec table module 112 includes tables 202 and 204 that have score fields 214. These score fields 214 in conjunction with the bit rate fields 216 allow the codec selection process module 110 to make codec selections based on more than one factor.

As should be clear from the foregoing discussion, the source computing device 102 may determine that each media signal type (e.g., audio and video) should have equal priority. In such a case, the exemplary codec selection process illustrated in FIGS. 4-6 may be used to, if possible, allocate equal or substantially equal amounts of bandwidth to the media signal types. Moreover, although the exemplary codec selection process illustrated in FIGS. 4-6 properly allocates amount of bandwidth to two media signal types, more than two media signal types may be processed by the illustrated process as well.

Exemplary Computing Device

FIG. 7 is an illustrative computing device that may be used to implement the source computing device 102 and the destination computing device 104. In a very basic configuration, the computing device 700 includes at least one processing unit 702 and system memory 704. Depending on the exact configuration and type of computing device 700, the system memory 704 may be volatile (such as RAM), non-volatile (such as ROM and flash memory) or some combination of the two. The system memory 704 typically includes an operating system 706, one or more program modules 708, and may include program data 710.

For the present codec selection implementations, the program modules 708 may include the codec selection process module 110. Other modules described herein may also be part of the program modules 708. As an alternative, the codec selection process module 110, as well as the other modules, may be implemented as part of the operating system 706, or it may be installed on the computing device and stored in other memory (e.g., non-removable storage 722) separate from the system memory 706, The repositories 114 and 118 may be included or separate from the system memory 706 as well.

The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 720 and non-removable storage 722. Computer storage media may include volatile and nonvolatile, removable and non-removable media implemented in any method or technology for storage of information, such as computer readable instructions, data structures, program modules, or other data. The system memory 706, removable storage 720 and non-removable storage 722 are all examples of computer storage media. Thus, computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of the device 700. Computing device 700 may also have input device(s) 724 such as keyboard, mouse, pen, voice input device, and touch input devices. Output device(s) 726 such as a display, speakers, printer, may also be included. These devices are well know in the art and need not be discussed at length.

The computing device 700 may also contain a communication connection 728 that allow the device to communicate with other computing devices 730, such as over a network like network 106 of FIG. 1. Communication connection(s) 728 is one example of communication media. Communication media may typically be embodied by computer readable instructions, data structures, program modules, or other data in a modulated data signal, such as a carrier wave or other transport mechanism, and includes any information delivery media.

Various modules and techniques may be described herein in the general context of computer-executable instructions, such as program modules, executed by one or more computers or other devices. Generally, program modules include routines, programs, objects, components, data structures, and so forth, for performing particular tasks or implement particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on or transmitted across some form of computer readable media.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method implemented at least in part by a computing device, comprising:
determining available network bandwidth; and
selecting, from a collection of codecs dissociated from a codec selection process, at least one codec based on at least the determined available network bandwidth.

2. A method as recited in claim 1, wherein the collection of codecs is part of at least one codec table stored in a computing device.

3. A method as recited in claim 1, wherein determining the available network bandwidth includes evaluating at least one of an amount of available bandwidth provided by a current communication session, a quality of a communication medium, and characteristics of one or more media signals for encoding.

4. A method as recited in claim 1, further comprising encoding a plurality of media signals only if the available network bandwidth is capable of supporting communication of the plurality of medial signals.

5. A method as recited in claim 4, wherein the plurality of media signals include a primary media signal and a secondary media signal.

6. A method as recited in claim 1, wherein selecting includes selecting a codec for a primary media signal and selecting another codec for a secondary media signal if the available network bandwidth is sufficient to support communication of encoded versions of the primary media signal and the secondary media signal simultaneously.

7. A method as recited in claim 1, further comprising:
evaluating if the available bandwidth is sufficient to support communication of a primary media signal and a secondary media signal; and
reevaluating if the available bandwidth is sufficient to support communication of a primary media signal and a secondary media signal after a codec is selected for encoding the primary medial signal.

8. A method as recited in claim 1, further comprising encoding only one of a plurality of media signals if the available network bandwidth is only capable of supporting communication of one of the plurality of medial signals.

9. A method as recited in claim 8, wherein the plurality of media signals includes an audio signal and a video signal, the audio signal being encoded in the act of encoding.

10. A computing device, comprising:
a codec selection module including computer-executable instructions for selecting codecs usable to encode media signals; and
a modifiable codec selection table independent of the codec selection module, the modifiable codec selection table including codec references selectable using the instructions of the codec selection module.

11. A system as recited in claim 10, wherein the modifiable codec selection table includes codecs references related to codecs used to encode audio and video media signals.

12. A system as recited in claim 10, further comprising a codec repository storing codecs referenced in the modifiable codec section table.

13. A system as recited in claim 10, wherein the modifiable codec selection table is modifiable or otherwise alterable without affecting the instructions of the codec selection module.

14. A system as recited in claim 10, wherein each of the codec references of the modifiable codec selection table includes a codec name field, a score field and a maximum bit rate field.

15. A system as recited in claim 10, further comprising a compression module that uses codecs to compress media signals.

16. A media encoding arrangement, comprising:
a codec table module having a plurality of codec references, each codec reference including a codec name field and a bit rate field; and
a codec repository including codecs referenced by the codec table module,
wherein changes to the codec table module and the codec repository do not affect a process for selecting codec references of the codec table module and codecs stored in the codec repository.

17. An arrangement as recited in claim 16, wherein each of the codec references includes a codec name field, a bit rate field and a score field, the codec name filed includes a name of a codec stored in the codec repository, the bit rate field includes a bit rate value that represents a maximum network bandwidth that is required by a codec identified in the codec name field, and the score field includes a score value representative of a computing device's processing capability.

18. An arrangement as recited in claim 16, wherein the codec table module includes an audio table with references to audio codecs and a video table with references to video codecs.

19. An arrangement as recited in claim 16, further comprising a codec selection process module that is independent of the codec table module and the codec repository.

20. An arrangement as recited in claim 19, wherein the codec selection process module includes computer-executable instructions for selecting codec references identified in the codec table module.
